(19) United States
(12) Patent Application Publication
(10) Pub. No.: US 2025/0115492 A1
(43) Pub. Date: Apr. 10, 2025

(54) STORMWATER AND INDUSTRIAL EFFLUENT BIOCHAR BASED FILTER MEDIA

(71) Applicant: BLUROCK INVESTMENTS, LLC, SAXONBURG, PA (US)

(72) Inventor: Michael A. Zock, Saxonburg, PA (US)

(21) Appl. No.: 18/908,597

(22) Filed: Oct. 7, 2024

Related U.S. Application Data
(60) Provisional application No. 63/588,134, filed on Oct. 5, 2023.

(51) Int. Cl. C02F 1/00; C02F 1/28; C02F 103/00; C02F 103/34

(52) U.S. Cl. CPC C02F 1/001; C02F 1/283; C02F 2103/001; C02F 2103/34

(57) ABSTRACT

A storm water and industrial effluent filter media comprising effective amounts of i) a char material comprising biochar, activated carbon and combinations thereof; and ii) a natural cellulose fiber comprising switchgrass, coconut husks and combinations thereof. One storm water and industrial effluent filter media according to the present invention comprises effective amounts of switchgrass, biochar, activated carbon, such as reactivated carbon, and, optionally, calcium silicate, such as calcium silicate aggregate. Methods of making storm water and industrial effluent filter media and a methods treating a fluid stream of stormwater or industrial effluent are also disclosed.

### RELATED APPLICATIONS

This application claims priority to U.S. provisional patent application Ser. No. 63/588,134 filed Oct. 5, 2023, titled “Stormwater Char Based Filter Media” which application is incorporated herein by reference in its entirety.

### BACKGROUND INFORMATION

### 1. Field of the Invention

The present invention relates to filter media for stormwater and industrial effluent applications, such as acid mine drainage applications, and specifically to a biochar based stormwater and industrial effluent filter media.

### 2. Background Information

The present invention relates general and overlapping fields of stormwater management including erosion, sediment and pollution control, and more specifically to filter media utilized in these fields. Erosion control, broadly, is the practice of preventing or controlling wind or water erosion in agriculture, land development, coastal areas, river banks and construction.

Effective erosion controls handle surface runoff and are important techniques in preventing water pollution, soil loss, wildlife habitat loss and human property loss. Sediment control is a practice designed to keep eroded soil within a perimeter, namely on a construction site, so that it does not wash off and cause water pollution to a nearby stream, river, lake, or sea. Sediment controls are usually employed together with erosion controls, which are designed to prevent or minimize erosion. Sediment controls are generally designed to be temporary measures, however, some can also be used for storm water management purposes.

Pollution control, in the context of this application, is the removal or limiting of specific contaminants within surface waters, and pollution control devices may be implemented with, or integrated within, erosion and sediment control devices. Many of these sediment erosion and/or pollution control devices utilize a filter media through which storm water passes. Within this application the terms erosion control device, pollution control device, industrial fluid runoff control device, sediment control device, stormwater management device or the like will be treated interchangeably unless otherwise noted.

For example, sediment filters are sediment-trapping devices typically used to remove pollutants (mainly particulates) from stormwater runoff. Sediment filters have four components: (1) inflow regulation, (2) pretreatment, (3) filter bed formed of filter media, and (4) outflow mechanism. Sediment chambers are one component of a sediment filter system.

A separate example is a compost filter sock represents another related device and it is a type of contained compost filter berm. The filter sock is typically a mesh tube filled with filtering material, such as (often) composted material, that is placed perpendicular to the direction of sheet flow to control erosion and retain sediment in disturbed areas. A compost filter sock has an oval or round cross-section and provides a three-dimensional filter to retain sediment and other pollutants (e.g., suspended solids, nutrients, metals and motor oil) and allow clean water to flow through. See EPA Stormwater best Management Practices: Compost Filter Sock December 2021.

Storm drain guards represent another example of a device that can utilize filter media through which storm water passes. Storm drain guards are simple devices designed to fit most drain catch basins. They're held in place by a metal grate, and, with a filter media added therein, they can effectively remove coarse sediments, oil, grease, litter, and debris from stormwater.

Stormwater related filter media devices are often used in MS4 compliance. There are approximately 7,250 permitted Municipal Separate Storm Sewer Systems (MS4s), including large and small MS4s that exist nationwide, operating under a National Pollutant Discharge Elimination System (NPDES) MS4 permit. The NPDES MS4 permit requires, permittees to develop and implement a comprehensive Storm Water Management Program (SWMP) that must include pollution prevention measures, treatment or removal techniques, monitoring, use of legal authority, and other appropriate measures to control the quality of storm water discharged to the storm drains and thence to waters of the United States.

Stream fluid treatment media has been used for treating industrial streams, aka effluent, such as related to acid mine drainage or acidic flows from industrial or related activities. Water resources are under continued pressure from anthropogenic sources, including acidic waste from abandoned mine sites and waste from a variety of industrial activities. Large quantities of mine and industrial wastes are typically stored in tailings facilities which can generate significant quantities of leachates due to weathering. In other words, material may be entrained within stormwater runoff. If released untreated to the aquatic environment these have the potential to contaminate surface and ground waters. In addition, generation of leachates from abandoned or closed sites presents a major long-term environmental challenge where the generation of leachates is expected to continue for decades, if not centuries, post closure. For further information see Thomas F. O'Dwyer, et al, Sustainable Treatment of Acidic and Alkaline Leachates from Mining and Industrial Activities: Current Practice and Future Perspectives; Wastewater Treatment, March 2022. See also Hudson A, Murnane J, Courtney R. EPA Research Report 400: Use of Constructed Wetlands for Treating Mine Waste Leachates: Assessment of Longevity and Management Implications (2018-W-DS-32). 2021.

As well as posing a serious threat to the environment and to human health, billions of dollars worth of valuable metals contained in industrial and domestic wastes are disposed of in hazardous waste disposal sites. See, for example, Murnane, J. G., Ghanim, B. M., Courtney, R., Pembroke, J. T. and O'Dwyer, T. F., 2021. Quantification and characterization of metals in alkaline leachates and the potential for vanadium adsorption using biochar and hydrochar, In AIP Conference Proceedings (Vol. 2441, No. 1, p. 020003). American Institute of Physics Publishing LLC. However, metal recovery from these wastes and associated leachates is for the most part technically difficult, uneconomical and unsustainable, primarily because the metals tend to be present in low concentrations and in complex matrices. Nevertheless, resource recovery has been identified as a necessary priority, particularly in an age where technological advancement is a key driver for global sustainability.

PFAS stands for perfluoroalkyl or polyfluoroalkyl substances, a group of chemicals that have properties that allow them to repel water, dirt, and oil. You may know them by an older term “PFCs,” or perfluorochemicals. Manufacturers use PFAS to make everyday household products Dubbed “forever chemicals,” PFAS chemicals don't break down easily over time and dissolve in water. There is concern that these chemicals could build to levels that could harm the environment and to humans. There is increasing efforts and regulations to remove these from stormwater and industrial effluents.

It is clear from the above that providing a cost effective efficient stormwater filter media and industrial effluent filter media is critical for many devices. It is one object of the present invention to provide a cost effective efficient stormwater and industrial effluent filter media.

### SUMMARY OF THE INVENTION

This invention is directed to a cost effective, efficient biochar based filter media for storm water and industrial effluent applications. The biochar is preferably a hardwood based biochar and preferably the filter media has a density of 450-550 lbs/yd³.

One storm water and industrial effluent filter media according to the present invention comprises effective amounts of a char material comprising biochar, activated carbon and combinations thereof and a natural cellulose fiber comprising switchgrass, coconut husks and combinations thereof.

One storm water and industrial effluent filter media according to the present invention comprises effective amounts of switchgrass, biochar, activated carbon, such as reactivated carbon, and, optionally, calcium silicate, such as calcium silicate aggregate.

One aspect of the present invention provides a method of treating a fluid stream of stormwater or industrial effluent comprising the steps of: a) providing a storm water and industrial effluent filter media within a tubular netting, wherein the filter media comprises a homogenized mixture comprising effective amounts of: i) a char material comprising biochar, activated carbon and combinations thereof; and ii) a natural cellulose fiber comprising switchgrass, coconut husks and combinations thereof; and placing the tubular netting filled with homogenized filter media within a fluid stream of stormwater or industrial effluent.

One aspect of the present invention provides a method of forming a storm water and industrial effluent filter media comprising the steps of a) homogenizing effective amounts of: i) a char material comprising biochar, activated carbon and combinations thereof; and ii) a natural cellulose fiber comprising switchgrass, coconut husks and combinations thereof; and b) packaging the homogenized mixture.

One industrial effluent filter media product comprises tubular netting, about 4′ long and 8″ diameter, filled with industrial filter media comprising effective amounts of switchgrass, biochar, activated carbon, and optionally calcium silicate.

One storm water filter media product comprises 8″, 12″, 18″ and 24″ diameter tubular netting, modular short sections such as 4′, 8′, 10′ or 12′ or continuous length coiled on pallet and filled with stormwater filter media comprising effective amounts of switchgrass, biochar, activated carbon, and calcium silicate.

One alternative stormwater filter media configured for submerged environments comprises effective amounts of biochar, and an additive comprising zeolite, activated carbon, coconut husk and ZVI.

These and other aspects of the present invention will be clarified in the description of the preferred embodiment of the present invention described below in connection with the attached figures in which like reference numerals represent like elements throughout.

### BRIEF DESCRIPTION OF THE FIGURES

FIGS. 1-3 schematically illustrate the homogenizing and packaging of the filter media according to embodiments of the present invention.

FIG. 4 schematically illustrate the homogenizing and packaging of the filter media according to embodiments of the present invention.

### DESCRIPTION OF THE PREFERRED EMBODIMENTS

A storm water and industrial effluent filter media 100 according to the present invention comprises effective amounts of i) a char material 10 comprising biochar 20, activated carbon 30 and combinations (collectively 10) thereof; and ii) a natural cellulose fiber 40 comprising switchgrass 50, coconut husks 60 and combinations thereof. Specific embodiments include other additives such as zeolite 70, ZVI 80 and calcium silicate 90 as discussed below.

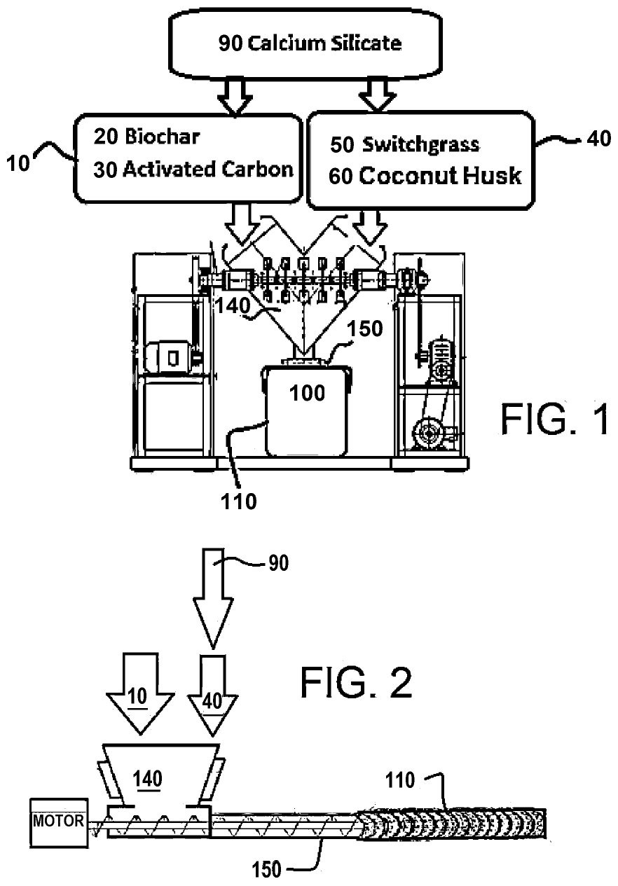

One storm water and industrial effluent filter media according to the present invention as shown in FIG. 1 comprises an homogenized blending of effective amounts of switchgrass 50, biochar 20, activated carbon 30, such as reactivated carbon, and, optionally, calcium silicate 90, such as calcium silicate aggregate. The methods of making the storm water and industrial effluent filter media 100 is also shown in FIG. 1.

### Char Material 10

All of the embodiments of filter media 100 within the present invention include a char material 10. A char material 10 within the meaning of the present invention comprises biochar 20, activated carbon 30 (preferably reactivated carbon) and combinations (collectively 10) thereof. These are discussed separately below.

### Biochar 20

Biochar 20 is the lightweight black residue, made of carbon and ashes, remaining after the pyrolysis of biomass, and is a form of charcoal. Biochar is defined by the International al Biochar Initiative as “the solid material obtained from the thermochemical conversion of biomass in an oxygen-limited environment”. Biochar 20 is a stable solid that is rich in pyrogenic carbon and can endure in soil for thousands of years. Biochar 20 in the present invention is a high-carbon, fine-grained residue that is produced via pyrolysis of hardwoods, such as in particular oaks, specifically red oak. It is the direct thermal decomposition of the hardwood biomass in the absence of oxygen (preventing combustion), which process produces a mixture of solids (the biochar), liquid (bio-oil), and gas (syngas) products. Gasifiers may be effectively used to form the biochar used in the present invention. The gasification process consists of four main stages: oxidation, drying, pyrolysis, and reduction. Temperature during pyrolysis in gasifiers is 250-550° C. (523-823 K), 600-800° C. (873-1,073 K) in the reduction.

The biochar 20 of the present invention is preferably hardwood based. Hardwood is wood from dicot trees. Hardwoods have a more complex structure than softwoods and are often much slower growing as a result. The dominant feature separating “hardwoods” from softwoods is the presence of pores, or vessels. A vessel (also known as vessel element or vessel member or xylem vessel) is one of the cell types found in xylem, the water conducting tissue of plants. The vessels may show considerable variation in size, shape of perforation plates (simple, scalariform, reticulate, foraminate), and structure of cell wall, such as spiral thickenings.

The biochar 20 of the present invention is often from oak. An oak is a tree or shrub in the genus of quercus of the beech family, Fagaceae. There are approximately 500 extant species of oaks. The biochar used in the present invention may be effectively formed from red oaks, Subgenus Quercus (the New World clade (or high-latitude clade), mostly native to North America); Section Lobatae (i.e., North American red oaks).

The biochar 20 used in the present invention is sized in larger particles, or chunky, such that the filter media 100 will yield a workable density of 450-550 lbs/yd³. The biochar 120 used in the invention may be screened to remove small/dust particles. This range yields a media that is still easily handled in the field and not too light as to easily wash away.

### Activated Carbon 30

Activated carbon 30, also called activated charcoal, is a form of carbon processed (activated) to have small, low-volume pores that increase the surface area available for adsorption or chemical reaction. Due to its high degree of micro-porosity, one gram of activated carbon has a surface area in excess of 3,000 m² (32,000 sq. ft.); whereas before activation, it may have a specific surface area in the range of 2.0-5.0 m²/g. Activated carbon 30 is carbon produced from carbonaceous source materials such as bamboo, coconut husk, willow peat, wood, coir, lignite, coal, and petroleum pitch.

Activated carbon 30 can be produced (activated) by one of physical activation or chemical activation. In physical activation the source material is developed into activated carbon using hot gases; air is then introduced to burn out the gasses, creating a graded, screened and de-dusted form of activated carbon. In chemical activation the carbon material is impregnated with certain chemicals. The chemical is typically an acid, strong base, or a salt. The carbon is then subjected to high temperatures. Chemical activation is often preferred to physical activation owing to the lower temperatures, better quality consistency, and shorter time needed for activating the material.

The activated carbon 30 is preferably “reactivated” carbon, also known as regenerated or reconstituted carbon. Activated carbon herein includes reactivated, regenerated or reconstituted carbon material. The reactivation or the regeneration of activated carbons involves restoring the adsorptive capacity of saturated activated carbon by desorbing adsorbed contaminants on the activated carbon surface. The most common regeneration technique employed in industrial processes is thermal reactivation. Per adsorption-thermal regeneration cycle, between 5-15 wt % of the carbon bed is burnt off resulting in a loss of adsorptive capacity. Some alternatives to thermal regeneration systems have been employed in the industry. Current alternative regeneration methods are: TSA (thermal swing adsorption) and/or PSA (pressure swing adsorption) processes; Microwave regeneration; Chemical and solvent regeneration; Microbial regeneration: Electro-chemical regeneration; Ultrasonic regeneration; and Wet air oxidation. The regenerated carbon yields an effective efficient choice for the activated carbon 30 material of the present invention.

### Natural Cellulose Fiber 40

All of the embodiments of filter media 100 within the present invention include a natural cellulose fiber 40. A natural cellulose fiber 40 within the meaning of the present invention comprises comprising switchgrass 50, coconut husks 60 and combinations thereof. These Are Discussed Separately Below.

### Switchgrass 50

Switchgrass 50 is a hardy, deep-rooted, perennial rhizomatous grass that begins growth in late spring. It can grow up to 2.7 m (8 ft 10 in) high, but is typically shorter than big bluestem grass or indian grass. The leaves are 30-90 cm (12-35 in) long, with a prominent midrib. Switchgrass 50 uses C4 carbon fixation, giving it an advantage in conditions of drought and high temperature. Switchgrass 50 is both a perennial and self-seeding crop, which means farmers do not have to plant and reseed after annual harvesting. Once established, a switchgrass stand can survive for ten years or longer. Switchgrass 50 can grow on marginal lands and requires relatively modest levels of chemical fertilizers. Overall, it is considered a resource-efficient, low-input crop now often used for producing bioenergy from farmland. The switchgrass 50 specifically used in the filter media 100 of the present invention is sized to minimize dust with 1″-6″ nominal lengths being effective, preferably 1″-5″, generally about 2″.

### Coconut Husk 60

Coconut husks 60 are the rough exterior shells of the coconut, and the coconut husk 60 material of the filter media 100 of the present invention is preferably chopped coconut husk material 60. In the industrial manufacturing, machinery holds the coconuts in position while sharpened points work the husks free. The meat and milk of the coconut can then be used to make a number of different food products, while the husks are subsequently chopped into chips or ground into a finer material, although chopping is preferred for the coconut husk 60 of the present invention. The coconut husk 60 used in forming the filter media 100 of the present invention may be de-dusted such as by screening to remove small/dust particles.

### Zeolite 70

Zeolite is used in some formulations of the filter media 100 of the present invention and zeolite 70 is a microporous, crystalline aluminosilicate material which mainly consists of silicon, aluminium, and oxygen. Zeolite 70 material occurs naturally and is produced industrially on a large scale. Over 250 unique zeolite frameworks have been identified, with over 40 naturally occurring zeolite frameworks are known. Zeolite 70 material is generally white solids with ordinary handling properties, like many routine aluminosilicate minerals and with a typical diameter of 0.3-0.8 nm. Like most aluminosilicates, the framework is formed by linking of aluminum and silicon atoms by oxides. This linking leads to a 3-dimensional network of Si—O—Al, Si—O—Si, and Al—O—Al linkages. The aluminum centers are negatively charged, which requires an accompanying cation. These cations are hydrated during the formation of the materials. The hydrated cations interrupt the otherwise dense network of Si—O—Al, Si—O—Si, and Al—O—Al linkage, leading to regular cavities. The porosity of the zeolite framework allows water to exit the material through channels. The rigidity of the zeolite framework prevents collapse of the cavities and channels.

### ZVI 80

Zero valent iron (ZVI) 80 is used in one embodiment of the filter media 100 of the present invention designed for largely submerged environments and describes forms of iron metal which, in use in the filter media 100, operates by electron transfer from Fe° toward some organochlorine compounds, a common class of pollutants. The remediation process generates Fe²⁺ and Cl⁻ and halide-free organic products, all of which are relatively innocuous. The ZVI 80 may be particulates formed from bulk Fe formed from scrap iron of construction grade, or Nanoscale Fe, namely nanoparticles (1-100 nm diameter) of zerovalent iron (ZVI).

It is noted that Zinc has showed much higher reactivity toward pentachlorophenol than iron. This indicates that zinc may be used as a replacement for ZVI 80 in the media 100 for dechlorinating chlorinated phenols. Thus in some applications the ZVI 80 material may be replaced zinc or with a ZVI-Zinc combination.

### Calsium Silicate 90

Calcium silicate 90, preferably calcium silicate aggregate, is used in some formulations of the filter media 100 of the present invention. Calcium silicate, also known as slag, is often produced when molten iron is made from iron ore, silicon dioxide and calcium carbonate in a blast furnace. It is often processed into a highly refined, re-purposed calcium silicate aggregate. When the filter media 100 of the invention includes calcium silicate 90 and it is used in the remediation of acid mine drainage (AMD) on active and passive mine sites (or similar effluents), the calcium silicate 90 neutralizes active acidity in AMD systems by removing free hydrogen ions from the bulk solution, thereby increasing pH. As its silicate anion captures H+ ions (raising the pH), it forms monosilicic acid (H₄SiO₄), a neutral solute. Monosilicic acid remains in the bulk solution to play other important roles in correcting the adverse effects of acidic conditions. As opposed to limestone (a popular remediation material), the calcium silicate 90 effectively precipitates heavy metals and does not armor over, prolonging its effectiveness in AMD systems and similar applications.

### Packaging 110

The filter media 100 may be effectively placed within a flexible bag 110 by bagger as shown in FIGS. 1 and 3 or the packaging 110 may be mesh tube or netting forming part of the product as shown in FIG. 2. For example one industrial effluent filter media product comprises tubular netting 110, about 4′ long and 8″ diameter, filled with industrial filter media 100 comprising effective amounts of switchgrass, biochar, activated carbon, and optionally calcium silicate. This netting may have handles for ease of placement and removal. One storm water filter media product comprises 8″, 12″, 18″ and 24″ diameter tubular netting 110, that may be in modular short sections such as 4′, 8′, 10′ or 12′ or may be a continuous length of netting 110 that is coiled on pallet and filled with stormwater filter media 100 comprising effective amounts of switchgrass, biochar, activated carbon, and calcium silicate.

### Method of Making (Mixer 140 and Bagger 150)

The method of forming a storm water and industrial effluent filter media 100 comprises the steps of a) homogenizing within a mixer 140 effective amounts of: i) a char material 10 comprising biochar 20, activated carbon 30 and combinations thereof; and ii) a natural cellulose fiber 40 comprising switchgrass 50, coconut husks 60 and combinations thereof; and packaging the homogenized mixture within the package 110.

FIGS. 1 and 3 shows the use of a dual axis mixing or blending unit with internal agitating paddles from BRIGHTSAIL machinery. The bagger 150 is shown as merely a discharge valve, but the bagger 150 may include a system for weighing the mixture forming the filter media 100 and for sealing the bag 110 to further automate the process. Alternatively, a hopper having a mixing/blending auger 140 as shown in FIG. 2 can be utilized to homogenize the filter media 100 prior to extruding at 150 into packaging or tubular netting 110.

EXAMPLE 1: One effective filter media for industrial effluent applications, like treating acid mine drainage, according to the present invention is 1500 lbs +/−300 lbs (two or three 600 lbs bales) switchgrass, 1000 lbs +/−100 lbs reactivated carbon, 700 lbs +/−70 lbs Biochar (about two cubic yards Biochar) and optionally up to 500 lbs calcium silicate, preferably 50-500 lbs +/−25 lbs. In this example the natural cellulose fiber 40 comprises switchgrass 50 with no coconut husks 60, while the char material 10 comprises a combination of biochar 20 and activated carbon 30. In this example it has been found that pollution affinity of the filter media 100 increases over a 6-12 month time period—as pollution affinity of char 10 decreases the pollution affinity of the switch grass 50 increases.

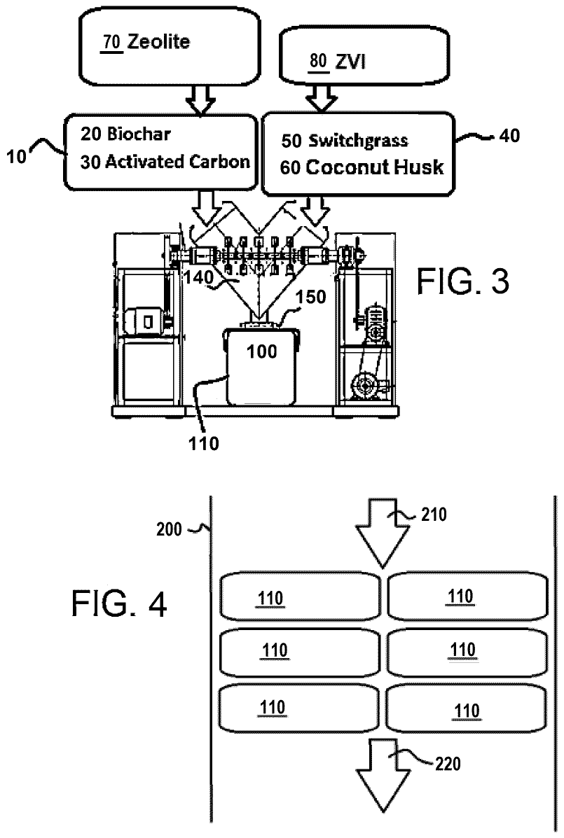

A method of treating a fluid stream of stormwater or industrial effluent comprising the steps of: providing a storm water and industrial effluent filter media 100 within a tubular netting 110, wherein the filter media 100 comprises a homogenized mixture within mixer 140 comprising effective amounts of: i) a char material 10 comprising combination of biochar 20 and activated carbon 30; and ii) a natural cellulose fiber 40 comprising switchgrass 50 (no coconut husks 60); a placing the tubular netting 110 filled with homogenized filter media 100 within a fluid stream 210 of stormwater or industrial effluent. FIG. 4 shows treatment of a stream 210 of industrial effluent, AMD, that is formed in channel 200 and an array of tubular netting 110 filled with homogenized filter media 100 is placed within the stream 220 allowing treated stream to pass through. The array may be replaced over time, either sequentially, row by row or all at once with the timing associated with the treatment regimen. This composition of filter media 100 is relatively shelf stable and may be manufactured in advance.

EXAMPLE 2: One embodiment effective filter media 100 for streams 210 of industrial effluent applications, particularly well-suited for PFAS remediation is 1200 lbs +/−120 lbs (two 600 lbs bales) switchgrass 50, 1000 lbs +/−100 lbs reactivated carbon 30, 700 lbs +/−70 lbs Biochar 20 (about two cubic yards Biochar), optionally up to 100 lbs calcium silicate 90, preferably 10-100 lbs +/−5 lbs. In this example the natural cellulose fiber 40 comprises switchgrass 50 with no coconut husks 60, while the char material 10 comprises a combination of biochar 20 and activated carbon 30. The method of use may be similar to that described above. As with example 1, in this example it has been found that pollution affinity of the filter media 100 increases over a 6-12 month time period—as pollution affinity of char 10 decreases the pollution affinity of the switch grass 50 increases. This composition of filter media 100 is relatively shelf stable and may be manufactured in advance.

EXAMPLE 3: One effective filter media 100 for streams 210 of industrial effluent applications, like treating acid mine drainage, comprises 10 lbs +/−3 lbs chopped switch grass 50, 35 lbs +/−3 lbs calcium silicate aggregate 90, and 5 lbs +/−1 lbs combination of biochar 20 and reactivated carbon 30, preferably the biochar 20 and reactivated carbon 30 are present in relatively equal parts by weight. In this example the natural cellulose fiber 40 comprises switchgrass 50 with no coconut husks 60, while the char material 10 comprises a combination of biochar 20 and activated carbon 30. The method of use may be similar to that described above. As with example 1, in this example it has been found that pollution affinity of the filter media 100 increases over a 6-12 month time period—as pollution affinity of char 10 decreases the pollution affinity of the switch grass 50 increases. This composition of filter media 100 is relatively shelf stable and may be manufactured in advance.

EXAMPLE 4: One effective filter media 100 for streams 210 of storm water applications is 1500 lbs +/−300 lbs (two or three 600 lbs bales bales) switchgrass 50, 1000lbs +/−100 lbs reactivated carbon 30, 700 lbs +/−70 lbs biochar 20 (about two cubic yards Biochar 20), optionally up to 100 lbs calcium silicate 90, preferably 10-100 lbs +/−5 lbs. In this example the natural cellulose fiber 40 comprising switchgrass 50 with no coconut husks 60, while the char material 10 comprises a combination of biochar 20 and activated carbon 30. The method of use may be similar to that described above. As with example 1, in this example it has been found that pollution affinity of the filter media 100 increases over a 6-12 month time period-as pollution affinity of char 10 decreases the pollution affinity of the switch grass 50 increases. This composition of filter media 100 is relatively shelf stable and may be manufactured in advance.

EXAMPLE 5: One effective filter media 100 for streams 210 of storm water applications includes 25 ft³+/−3 ft³ chopped switch grass 50, ½-2 ft³+/−½ ft³ calcium silicate aggregate 90, and ½-2 ft³+/−½ ft³ biochar 20 and ½-2 ft³+/−½ ft³ activated carbon 30. In this example the natural cellulose fiber 40 comprises switchgrass 50 with no coconut husks 60, while the char material 10 comprises a combination of biochar 20 and activated carbon 30. The method of use may be similar to that described above. This composition of filter media 100 is relatively shelf stable and may be manufactured in advance.

EXAMPLE 6: One alternative stormwater filter media 100 configured for submerged environments comprises effective amounts of biochar 20, and an additive mixture comprising zeolite 70, activated carbon 30, coconut husk 70 and ZVI 80. In this embodiment the majority of the filter media 100, by volume, is formed of biochar 20. The additives form less than 50% by volume of the filter media 100. For 50 volumetric parts biochar 20 the filter media 100 is formed of 4-40 volumetric parts additives, specifically 1 -10 parts zeolite 70, 1-10 parts activated carbon 30, 1-10 parts coconut husk 60 and 1-10parts ZVI 80. An effective filter media 100 of this general type has been formed with 50 parts biochar 20, 2 parts zeolite 70, 2 parts activated carbon 30, 2 parts coconut husk 60 and 2 parts ZVI 80 by volume. In this example the stormwater filter media 100 comprising effective amounts of biochar 20 combined with additives including zeolite 70, activated carbon 30, coconut husk 60 and ZVI 80 may serve as a sole filter media in stormwater management devices or may be used as an additive in the filter media of such devices. For example the filter media 100 may completely fill a compost filter sock for certain applications (e.g., surrounding an inlet grate), or may be mixed in a 1-1 to a 1-20 ratio with conventional “compost” filler.

It is apparent that many variations to the present invention may be made without departing from the spirit and scope of the invention. The present invention is defined by the appended claims and equivalents thereto.

What is claimed is:

1. A storm water and industrial effluent filter media comprising effective amounts of:
i) a char material comprising biochar, activated carbon and combinations thereof; and
ii) a natural cellulose fiber comprising switchgrass, coconut husks and combinations thereof.

2. The storm water and industrial effluent filter media according to claim 1 wherein the natural cellulose fiber comprising switchgrass.

3. The storm water and industrial effluent filter media according to claim 2 wherein switchgrass is chopped switchgrass having nominal length of 1″-6″.

4. The storm water and industrial effluent filter media according to claim 2 wherein the char material comprises a combination of biochar and activated carbon.

5. The storm water and industrial effluent filter media according to claim 4 wherein the activated carbon comprises reactivated carbon.

6. The storm water and industrial effluent filter media according to claim 5 further including calcium silicate.

7. The storm water and industrial effluent filter media according to claim 6 wherein the calcium silicate comprises calcium silicate aggregate.

8. The storm water and industrial effluent filter media according to claim 5 wherein the filter media is placed in a tubular netting.

9. A method of forming a storm water and industrial effluent filter media comprising the steps of
A) homogenizing effective amounts of:
i) a char material comprising biochar, activated carbon and combinations thereof; and
ii) a natural cellulose fiber comprising switchgrass, coconut husks and combinations thereof;
B) packaging the homogenized mixture.

10. The method of forming a storm water and industrial effluent filter media according to claim 9 wherein the natural cellulose fiber comprising switchgrass.

11. The method of forming a storm water and industrial effluent filter media according to claim 10 wherein switchgrass is chopped switchgrass having nominal length of 1″-6″.

12. The method of forming a storm water and industrial effluent filter media according to claim 10 wherein the char material comprises a combination of biochar and activated carbon.

13. The method of forming a storm water and industrial effluent filter media according to claim 12 wherein the activated carbon comprises reactivated carbon.

14. The method of forming a storm water and industrial effluent filter media according to claim 13 further including calcium silicate.

15. The method of forming a storm water and industrial effluent filter media according to claim 14 wherein the calcium silicate comprises calcium silicate aggregate.

16. The method of forming a storm water and industrial effluent filter media according to claim 12 wherein the packaging the homogenized mixture includes placing the homogenized mixture in a tubular netting.

17. A method of treating a fluid stream of stormwater or industrial effluent comprising the steps of:
A) Providing a storm water and industrial effluent filter media within a tubular netting, wherein the filter media comprises a homogenized mixture comprising effective amounts of:
i) a char material comprising biochar, activated carbon and combinations thereof; and
ii) a natural cellulose fiber comprising switchgrass, coconut husks and combinations thereof;
B) Placing the tubular netting filled with homogenized filter media within a fluid stream of stormwater or industrial effluent.

18. The method of treating a fluid stream of stormwater or industrial effluent according to claim 17 wherein the natural cellulose fiber comprises switchgrass.

19. The method of treating a fluid stream of stormwater or industrial effluent according to claim 18 wherein the char material comprises a combination of biochar and activated carbon.

20. The method of treating a fluid stream of stormwater or industrial effluent according to claim 18 wherein the filter media further includes calcium silicate.
